(19) United States
(12) Patent Application Publication
(10) Pub. No.: US 2024/0056265 A1
(43) Pub. Date: Feb. 15, 2024

(54) METHOD AND DEVICE FOR SWITCHING BETWEEN 320 MHZ CHANNELS IN WIRELESS LAN SYSTEM

(71) Applicant: LG ELECTRONICS INC., Seoul (KR)

(72) Inventors: Insun JANG, Seoul (KR); Jeongki KIM, Seoul (KR); Jinsoo CHOI, Seoul (KR); Namyeong KIM, Seoul (KR); Sunhee BAEK, Seoul (KR)

(73) Assignee: LG ELECTRONICS INC., Seoul (KR)

(21) Appl. No.: 18/255,028

(22) PCT Filed: Dec. 21, 2021
(86) PCT No.: PCT/KR2021/019448

§ 371 Date: May 30, 2023

(30) Foreign Application Priority Data
Dec. 28, 2020 (KR) 10-2020-0184097
Dec. 29, 2020 (KR) 10-2020-0186439

(51) Int. Cl. H04L 5/00; H04W 72/0453

(52) U.S. Cl. CPC H04L 5/0064; H04L 5/0091; H04W 72/0453; H04W 84/12

(57) ABSTRACT

Proposed are a method and device for switching between 320 MHz channels in a wireless LAN system. Specifically, a reception STA receives a beacon frame from a transmission STA through a first 320 MHz channel. The reception STA receives an EHT OM field from the transmission STA through the first 320 MHz channel. The reception STA receives a beacon frame from the transmission STA through a second 320 MHz channel. BSS channels of the transmission and reception STAs are switched from the first 320 MHz channel to the second 320 MHz channel on the basis of the beacon frame and the EHT OM field.

### CROSS-REFERENCE TO RELATED APPLICATIONS

This application is the National Stage filing under 35 U.S.C. 371 of International Application No. PCT/KR2021/019448, filed on Dec. 21, 2021, which claims the benefit of earlier filing date and right of priority to Korean Application Nos. 10-2020-0184097, filed on Dec. 28, 2020, and 10-2020-0186439, filed on Dec. 29, 2020, the contents of which are all hereby incorporated by reference herein in their entireties.

### TECHNICAL FIELD

The present specification relates to channel utilization in a 6 GHz band in a wireless LAN system, and more particularly, to a method and apparatus for performing a change between 320 MHz channels.

### BACKGROUND

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### SUMMARY

The present specification proposes a method and apparatus for performing a change between 320 MHz channels in a WLAN system.

An example of this specification proposes a method for performing a change between 320 MHz channels.

The present embodiment may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

This embodiment proposes a method and apparatus for performing BSS channel change between a 320-1 MHz channel and a 320-2 MHz channel channelized in a 6 GHz band. Here, it is assumed that overlapping primary 160 MHz channels exist in the 320-1 MHz channel and the 320-2 MHz channel. A transmitting STA may correspond to an Access Point Station (AP STA), and a receiving STA may correspond to a non-AP STA.

A receiving STA (station) receives a beacon frame from a transmitting STA through a first 320 MHz channel.

The receiving STA receives an Extreme High Throughput (EHT) Operating Mode (OM) field from the transmitting STA through the first 320 MHz channel.

The receiving STA receives the beacon frame from the transmitting STA through a second 320 MHz channel.

A Basic Service Set (BSS) channel of the transmitting and receiving STAs is changed from the first 320 MHz channel to the second 320 MHz channel based on the beacon frame and the EHT OM field.

According to the embodiment proposed in this specification, the AP may perform switching between the first and second 320 MHz channels to increase channel utilization. In this case, since it is assumed that the primary 160 MHz channels of the first and second 320 MHz channels overlap each other, there is an effect that overhead can be reduced compared to the existing channel switching method by proposing a switching method for changing only the secondary channels of the first and second 320 MHz channels without changing the primary 160 MHz channel.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates an operation based on UL-MU.

FIG. 6 illustrates an example of a trigger frame.

FIG. 7 illustrates an example of a common information field of a trigger frame.

FIG. 8 illustrates an example of a subfield included in a per user information field.

FIG. 9 describes a technical feature of the UORA scheme.

FIG. 10 illustrates an example of a PPDU used in the present specification.

FIG. 11 illustrates an example of a modified transmission device and/or receiving device of the present specification.

FIG. 12 shows channelization of the 6 GHz band.

FIG. 13 shows an example in which a BSS channel is changed.

FIG. 14 shows an example of fields for an EHT BSS channel.

FIG. 15 shows an example of a field for an EHT BSS channel that can indicate two BSS channels.

FIG. 16 shows an example of a CCFS subfield in a field for the EHT BSS channel of FIG. 15.

FIG. 17 shows an example of a field for an EHT BSS channel including a 320 MHz Control field.

FIG. 18 shows an example of a CCFS subfield in a field for an EHT BSS channel that can indicate both a 320-1 MHz channel and a 320-2 MHz channel with overlapping channels.

FIG. 19 shows another example of a field for an EHT BSS channel including a 320 MHz Control field.

FIG. 20 shows an example of a legacy OM field format.

FIG. 21 shows an example of an EHT OM field for notifying a BSS channel change.

FIG. 22 shows an example of notifying a BSS channel change through method A-1) using an EHT OM field and an EHT Operation IE.

FIG. 23 shows an example of notifying a BSS channel change through method A-3) using an EHT OM field and an EHT Operation IE.

FIG. 24 is a flowchart illustrating a procedure in which an AP indicates a change of a 320 MHz channel according to the present embodiment.

FIG. 25 is a flowchart illustrating a procedure in which an STA is indicated to change a 320 MHz channel according to this embodiment.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

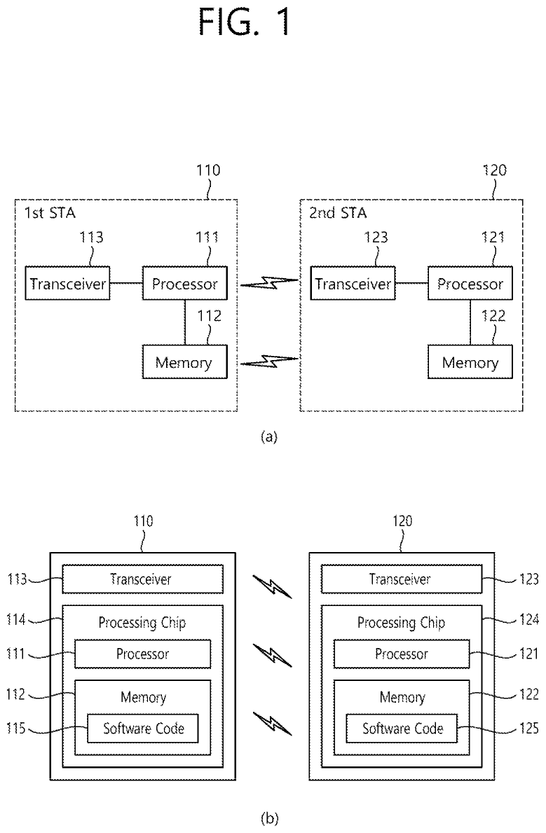

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP′, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP′, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

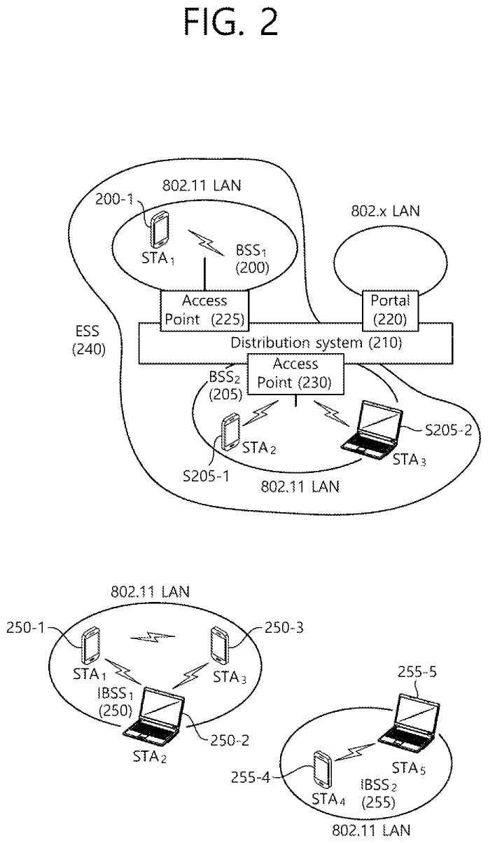

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (S SID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

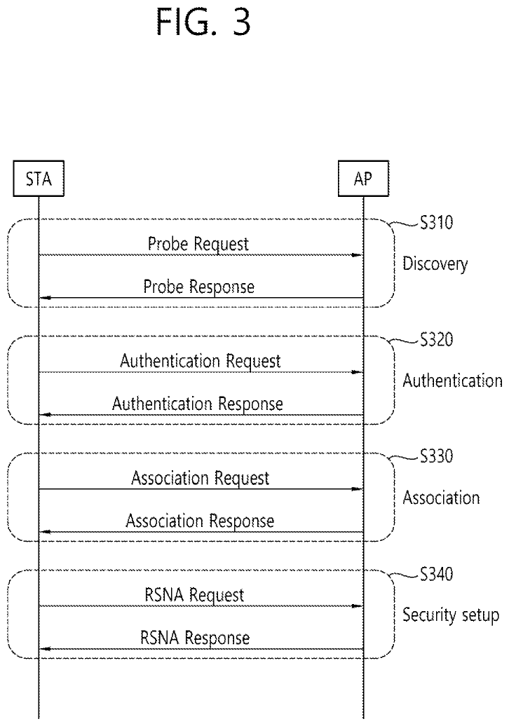

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information related to a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information related to an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information related to various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information related to various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

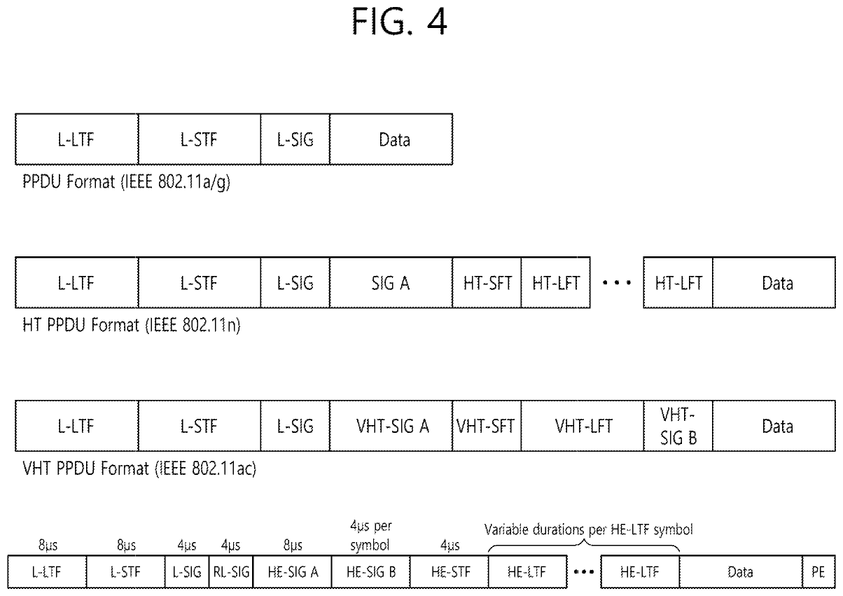

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

The RU described in the present specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU, etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

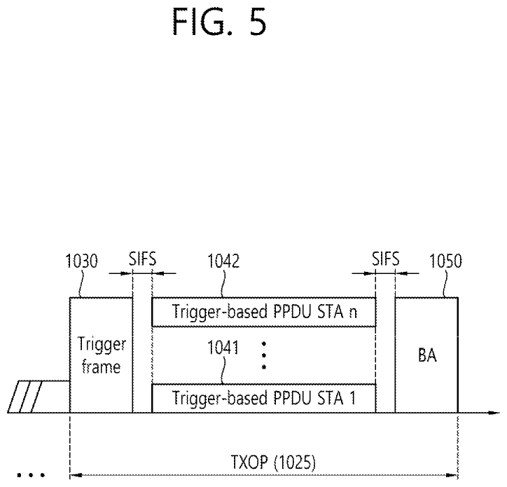

FIG. 5 illustrates an operation based on UL-MU. As illustrated, a transmitting STA (e.g., an AP) may perform channel access through contending (e.g., a backoff operation), and may transmit a trigger frame 1030. That is, the transmitting STA may transmit a PPDU including the trigger frame 1030. Upon receiving the PPDU including the trigger frame, a trigger-based (TB) PPDU is transmitted after a delay corresponding to SIFS.

TB PPDUs 1041 and 1042 may be transmitted at the same time period, and may be transmitted from a plurality of STAs (e.g., user STAs) having AIDs indicated in the trigger frame 1030. An ACK frame 1050 for the TB PPDU may be implemented in various forms.

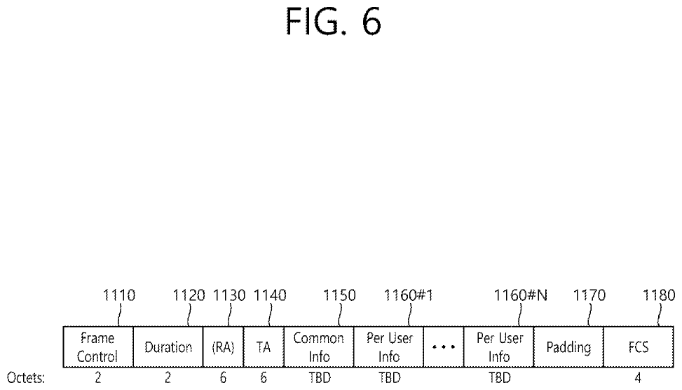

A specific feature of the trigger frame is described with reference to FIG. 6 to FIG. 8. Even if UL-MU communication is used, an orthogonal frequency division multiple access (OFDMA) scheme or a MU MIMO scheme may be used, and the OFDMA and MU-MIMO schemes may be simultaneously used.

FIG. 6 illustrates an example of a trigger frame. The trigger frame of FIG. 6 allocates a resource for uplink multiple-user (MU) transmission, and may be transmitted, for example, from an AP. The trigger frame may be configured of a MAC frame, and may be included in a PPDU.

Each field shown in FIG. 6 may be partially omitted, and another field may be added. In addition, a length of each field may be changed to be different from that shown in the figure.

A frame control field 1110 of FIG. 6 may include information related to a MAC protocol version and extra additional control information. A duration field 1120 may include time information for NAV configuration or information related to an identifier (e.g., AID) of a STA.

In addition, an RA field 1130 may include address information of a receiving STA of a corresponding trigger frame, and may be optionally omitted. A TA field 1140 may include address information of a STA (e.g., an AP) which transmits the corresponding trigger frame. A common information field 1150 includes common control information applied to the receiving STA which receives the corresponding trigger frame. For example, a field indicating a length of an L-SIG field of an uplink PPDU transmitted in response to the corresponding trigger frame or information for controlling content of a SIG-A field (i.e., HE-SIG-A field) of the uplink PPDU transmitted in response to the corresponding trigger frame may be included. In addition, as common control information, information related to a length of a CP of the uplink PPDU transmitted in response to the corresponding trigger frame or information related to a length of an LTF field may be included.

In addition, per user information fields 1160 #1 to 1160 #N corresponding to the number of receiving STAs which receive the trigger frame of FIG. 6 are preferably included. The per user information field may also be called an “allocation field”.

In addition, the trigger frame of FIG. 6 may include a padding field 1170 and a frame check sequence field 1180.

Each of the per user information fields 1160 #1 to 1160 #N shown in FIG. 6 may include a plurality of subfields.

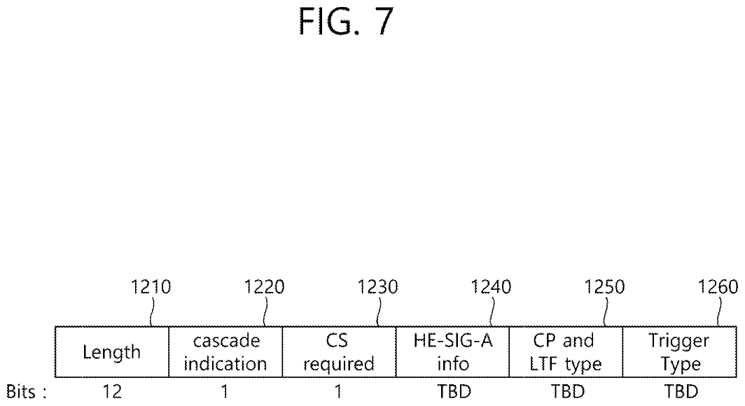

FIG. 7 illustrates an example of a common information field of a trigger frame. A subfield of FIG. 7 may be partially omitted, and an extra subfield may be added. In addition, a length of each subfield illustrated may be changed.

A length field 1210 illustrated has the same value as a length field of an L-SIG field of an uplink PPDU transmitted in response to a corresponding trigger frame, and a length field of the L-SIG field of the uplink PPDU indicates a length of the uplink PPDU. As a result, the length field 1210 of the trigger frame may be used to indicate the length of the corresponding uplink PPDU.

In addition, a cascade identifier field 1220 indicates whether a cascade operation is performed. The cascade operation implies that downlink MU transmission and uplink MU transmission are performed together in the same TXOP. That is, it implies that downlink MU transmission is performed and thereafter uplink MU transmission is performed after a pre-set time (e.g., SIFS). During the cascade operation, only one transmitting device (e.g., AP) may perform downlink communication, and a plurality of transmitting devices (e.g., non-APs) may perform uplink communication.

A CS request field 1230 indicates whether a wireless medium state or a NAV or the like is necessarily considered in a situation where a receiving device which has received a corresponding trigger frame transmits a corresponding uplink PPDU.

An HE-SIG-A information field 1240 may include information for controlling content of a SIG-A field (i.e., HE-SIG-A field) of the uplink PPDU in response to the corresponding trigger frame.

A CP and LTF type field 1250 may include information related to a CP length and LTF length of the uplink PPDU transmitted in response to the corresponding trigger frame. A trigger type field 1260 may indicate a purpose of using the corresponding trigger frame, for example, typical triggering, triggering for beamforming, a request for block ACK/NACK, or the like.

It may be assumed that the trigger type field 1260 of the trigger frame in the present specification indicates a trigger frame of a basic type for typical triggering. For example, the trigger frame of the basic type may be referred to as a basic trigger frame.

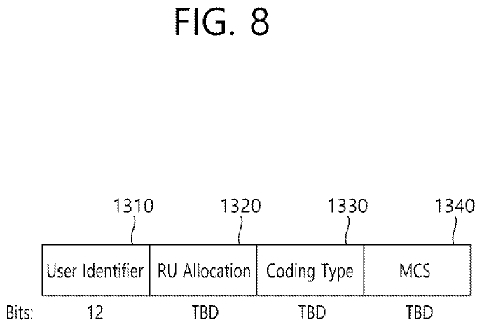

FIG. 8 illustrates an example of a subfield included in a per user information field. A user information field 1300 of FIG. 8 may be understood as any one of the per user information fields 1160 #1 to 1160 #N mentioned above with reference to FIG. 6. A subfield included in the user information field 1300 of FIG. 8 may be partially omitted, and an extra subfield may be added. In addition, a length of each subfield illustrated may be changed.

A user identifier field 1310 of FIG. 8 indicates an identifier of a STA (i.e., receiving STA) corresponding to per user information. An example of the identifier may be the entirety or part of an association identifier (AID) value of the receiving STA.

In addition, an RU allocation field 1320 may be included. That is, when the receiving STA identified through the user identifier field 1310 transmits a TB PPDU in response to the trigger frame, the TB PPDU is transmitted through an RU indicated by the RU allocation field 1320.

The subfield of FIG. 8 may include a coding type field 1330. The coding type field 1330 may indicate a coding type of the TB PPDU. For example, when BCC coding is applied to the TB PPDU, the coding type field 1330 may be set to ‘1’, and when LDPC coding is applied, the coding type field 1330 may be set to ‘0’.

In addition, the subfield of FIG. 8 may include an MCS field 1340. The MCS field 1340 may indicate an MCS scheme applied to the TB PPDU. For example, when BCC coding is applied to the TB PPDU, the coding type field 1330 may be set to ‘1’, and when LDPC coding is applied, the coding type field 1330 may be set to ‘0’.

Hereinafter, a UL OFDMA-based random access (UORA) scheme will be described.

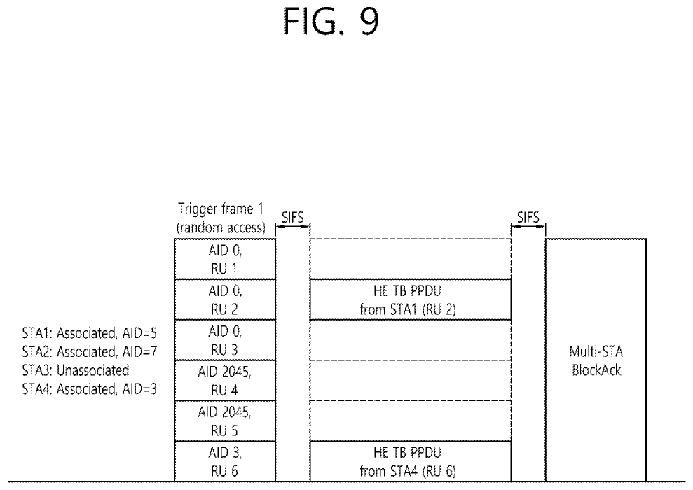

FIG. 9 describes a technical feature of the UORA scheme.

A transmitting STA (e.g., an AP) may allocate six RU resources through a trigger frame as shown in FIG. 9. Specifically, the AP may allocate a 1st RU resource (AID 0, RU 1), a 2nd RU resource (AID 0, RU 2), a 3rd RU resource (AID 0, RU 3), a 4th RU resource (AID 2045, RU 4), a 5th RU resource (AID 2045, RU 5), and a 6th RU resource (AID 3, RU 6). Information related to the AID 0, AID 3, or AID 2045 may be included, for example, in the user identifier field 1310 of FIG. 8. Information related to the RU 1 to RU 6 may be included, for example, in the RU allocation field 1320 of FIG. 8. AID=0 may imply a UORA resource for an associated STA, and AID=2045 may imply a UORA resource for an un-associated STA. Accordingly, the 1st to 3rd RU resources of FIG. 9 may be used as a UORA resource for the associated STA, the 4th and 5th RU resources of FIG. 9 may be used as a UORA resource for the un-associated STA, and the 6th RU resource of FIG. 9 may be used as a typical resource for UL MU.

In the example of FIG. 9, an OFDMA random access backoff (OBO) of a STA1 is decreased to 0, and the STA1 randomly selects the 2nd RU resource (AID 0, RU 2). In addition, since an OBO counter of a STA2/3 is greater than 0, an uplink resource is not allocated to the STA2/3. In addition, regarding a STA4 in FIG. 9, since an AID (e.g., AID=3) of the STA4 is included in a trigger frame, a resource of the RU 6 is allocated without backoff.

Specifically, since the STA1 of FIG. 9 is an associated STA, the total number of eligible RA RUs for the STA1 is 3 (RU 1, RU 2, and RU 3), and thus the STA1 decreases an OBO counter by 3 so that the OBO counter becomes 0. In addition, since the STA2 of FIG. 9 is an associated STA, the total number of eligible RA RUs for the STA2 is 3 (RU 1, RU 2, and RU 3), and thus the STA2 decreases the OBO counter by 3 but the OBO counter is greater than 0. In addition, since the STA3 of FIG. 9 is an un-associated STA, the total number of eligible RA RUs for the STA3 is 2 (RU 4, RU 5), and thus the STA3 decreases the OBO counter by 2 but the OBO counter is greater than 0.

Hereinafter, a PPDU transmitted/received in a STA of the present specification will be described.

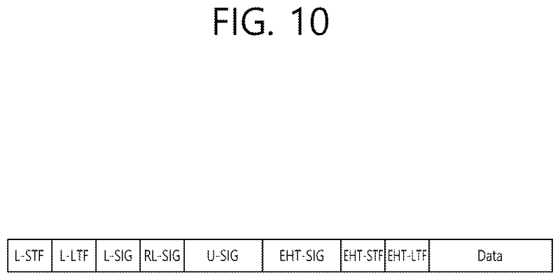

FIG. 10 illustrates an example of a PPDU used in the present specification.

The PPDU of FIG. 10 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 10 may indicate the entirety or part of a PPDU type used in the EHT system. For example, the example of FIG. 10 may be used for both of a single-user (SU) mode and a multi-user (MU) mode. In other words, the PPDU of FIG. 10 may be a PPDU for one receiving STA or a plurality of receiving STAs. When the PPDU of FIG. 10 is used for a trigger-based (TB) mode, the EHT-SIG of FIG. 10 may be omitted. In other words, an STA which has received a trigger frame for uplink-MU (UL-MU) may transmit the PPDU in which the EHT-SIG is omitted in the example of FIG. 10.

In FIG. 10, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 10 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 10, the L-LTE and the L-STF may be the same as those in the conventional fields.

The L-SIG field of FIG. 10 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI or the EHT PPDU, the value of the length field may be determined as a multiple of 3, and for the HE PPDU, the value of the length field may be determined as “a multiple of 3”+1 or “a multiple of 3”+2.

For example, the transmitting STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index{-28, −27, +27, +28}. The aforementioned signal may be used for channel estimation on a frequency domain corresponding to {−28, −27, +27, +28}.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 10. The U-SIB may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

Through the U-SIG (or U-SIG field), for example, A-bit information (e.g., 52 un-coded bits) may be transmitted. A first symbol of the U-SIG may transmit first X-bit information (e.g., 26 un-coded bits) of the A-bit information, and a second symbol of the U-SIB may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index−28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, “000000”.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits may indicate that the TX/RX PPDU is an EHT PPDU. In other words, when the transmitting STA transmits the EHT PPDU, the PHY version identifier of 3 bits may be set to a first value. In other words, the receiving STA may determine that the RX PPDU is the EHT PPDU, based on the PHY version identifier having the first value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a TXOP length and information related to a BSS color ID.

For example, when the EHT PPDU is divided into various types (e.g., various types such as an EHT PPDU related to an SU mode, an EHT PPDU related to a MU mode, an EHT PPDU related to a TB mode, an EHT PPDU related to extended range transmission, or the like), information related to the type of the EHT PPDU may be included in the version-dependent bits of the U-SIG.

For example, the U-SIG may include: 1) a bandwidth field including information related to a bandwidth; 2) a field including information related to an MCS scheme applied to EHT-SIG; 3) an indication field including information regarding whether a dual subcarrier modulation (DCM) scheme is applied to EHT-SIG; 4) a field including information related to the number of symbol used for EHT-SIG; 5) a field including information regarding whether the EHT-SIG is generated across a full band; 6) a field including information related to a type of EHT-LTF/STF; and 7) information related to a field indicating an EHT-LTF length and a CP length.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 10. The PPDU of FIG. 10 may be used to transmit/receive frames of various types. For example, the PPDU of FIG. 10 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 10 may be used for a management frame. An example of the management frame may include a beacon frame, a (re-)association request frame, a (re-)association response frame, a probe request frame, and a probe response frame. For example, the PPDU of FIG. 10 may be used for a data frame. For example, the PPDU of FIG. 10 may be used to simultaneously transmit at least two or more of the control frames, the management frame, and the data frame.

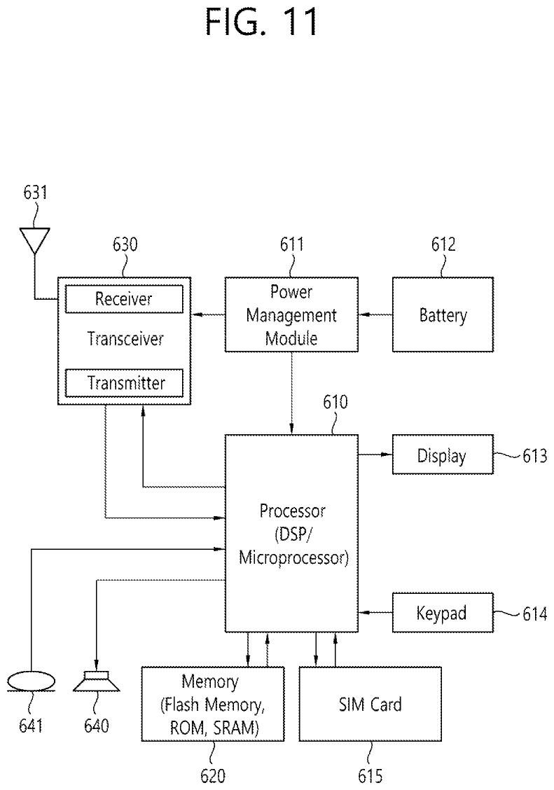

FIG. 11 illustrates an example of a modified transmission device and/or receiving device of the present specification.

Each device/STA of the sub-figure (a)/(b) of FIG. 1 may be modified as shown in FIG. 11. A transceiver 630 of FIG. 11 may be identical to the transceivers 113 and 123 of FIG. 1. The transceiver 630 of FIG. 11 may include a receiver and a transmitter.

A processor 610 of FIG. 11 may be identical to the processors 111 and 121 of FIG. 1. Alternatively, the processor 610 of FIG. 11 may be identical to the processing chips 114 and 124 of FIG. 1.

A memory 620 of FIG. 11 may be identical to the memories 112 and 122 of FIG. 1. Alternatively, the memory 620 of FIG. 11 may be a separate external memory different from the memories 112 and 122 of FIG. 1.

Referring to FIG. 11, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 11, a speaker 640 may output a result related to a sound processed by the processor 610. A microphone 641 may receive an input related to a sound to be used by the processor 610.

1. Channelization of 6 GHz Band

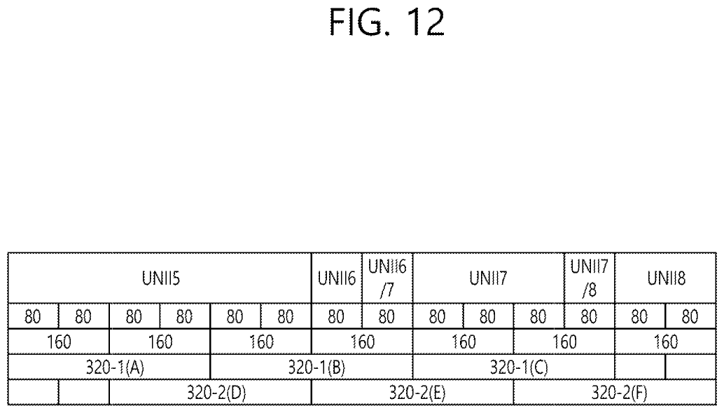

FIG. 12 shows channelization of the 6 GHz band.

EHT (802.11be) supports not only the 160 MHz bandwidth (BW) that has been supported up to 802.11ax, but also the wider BW (BandWidth), 320 MHz. In the existing 20/40/80/160 MHz channelization, overlapping channels did not exist. However, for 320 MHz BW, overlapping channels are included, such as 320-1 MHz and 320-2 MHz in FIG. 12. An overlapping channel may or may not exist between the 320-1 MHz channel and the 320-2 MHz channel. For example, although channels 320-1 (A) and 320-2 (D) in FIG. 12 have overlapping channels of 160 MHz BW, Channel 320-1 (A) and channel 3202-2 (E) do not have overlapping channels. Meanwhile, the current 320-1 MHz channel and the 320-2 MHz channel are separately signaled in the BW subfield of the Universal Signal (U-SIG) field of the EHT PPDU. In the present specification, a 160 MHz channel including a primary channel (i.e., a 20 MHz primary channel) is referred to as P160 and a 160 MHz channel not including the primary channel is referred to as S160.

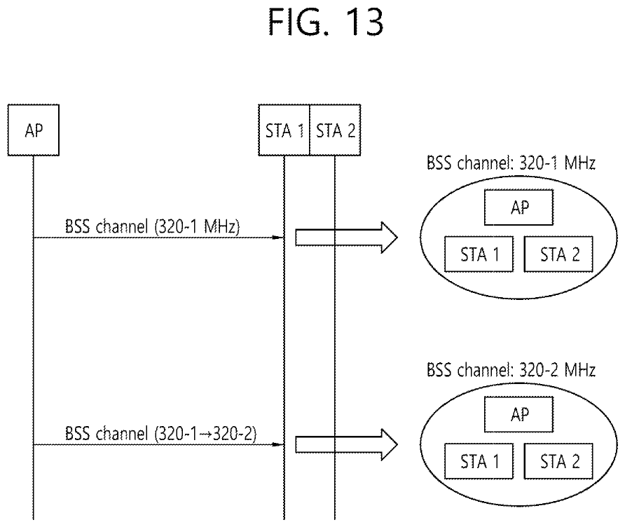

Channel movement between the 320-1 MHz channel and the 320-2 MHz channel can use the existing channel switching method (e.g., channel switching announcement), but movement between 320 MHz channels assumes that P160 overlaps (or is shared), so existing channel switching methods can be burdensome in terms of overhead. Therefore, the present specification proposes a method for performing flexible BSS channel change between 320-1 MHz and 320-2 MHz channels through a method capable of reducing existing heavy operations and increasing channel utilization. For example, in case of channel 320-1 (A) and channel 320-2 (D) in FIG. 12, the overlapping channel of 160 MHz BW is P160, BSS channel change can be performed by signaling that only S160 can be changed without changing P160. That is, the BSS channel can be changed through a simple instruction as shown in FIG. 13.

FIG. 13 shows an example in which a BSS channel is changed.

Referring to FIG. 13, the AP informs STA1 and STA2 that the BSS channel is 320-1 MHz. When the BSS channel needs to be changed, the AP may notify STA1 and STA2 that the BSS channel is changed from 320-1 MHz to 320-2 MHz through signaling.

This specification proposes a method for changing a BSS channel. The designation (name) described in this specification may be changed, and the station (STA) may include an AP STA or a non-AP STA.

### 2. Embodiments Applicable to this Specification

Basically, channelization of 320-1 MHz and 320-2 MHz is based on FIG. 12. Accordingly, signaling for 320 MHz BW may be performed in consideration of the presence and absence of overlapping channels.

The indication for the BSS channel including 320 MHz BW may consist of Channel Width, Primary channel, one or more CCFS like the existing baseline (e.g., 802.11ac/ax), but is not limited thereto.

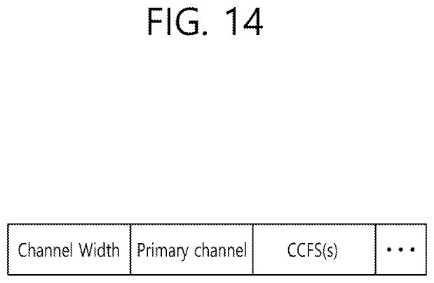

FIG. 14 shows an example of fields for an EHT BSS channel.

Basically, the contents of the fields for the EHT BSS channel of FIG. 14 are as follows, but the contents of each field may be changed according to cases and methods described below. In addition, since signaling for 320 MHz BW is premised in this specification, it is described based on the case where the channel width is 320 MHz.
1) Channel Width

The contents of the Channel Width field are defined as follows.

TABLE 1

| Subfield | Definition | Encoding |
|---|---|---|
| Channel | This field defines | Set to 0 for 20 MHz EHT BSS |
| Width | the EHT BSS | bandwidthSet to 1 for 40 MHz |
| | bandwidth | EHT BSS bandwidth |
| | | Set to 2 for 80 MHz EHT BSS |
| | | bandwidth |
| | | Set to 3 for 160 MHz EHT BSS |
| | | bandwidth |
| | | Set to 4 for 320 MHz EHT BSS |
| | | bandwidth |
| | | Other values are reserved. |

2) Primary channel: Channel number of the primary channel
3) CCFSs: Channel Center Frequency Segment (for 320 MHz)
3-1) EHT_CCFS0: Channel Center Frequency index of P160
3-2) EHT_CCFS1: Channel Center Frequency index for 320 MHz channel

2.1. When Overlapping Channels (e.g., 160 MHz) Exist in the 320-1 BW Channel and the 320-2 BW Channel

Basically, methods can be classified according to Channel Width signaling.

2.1.1. When 320-1 MHz and 320-2 MHz are Separately Indicated in Channel Width

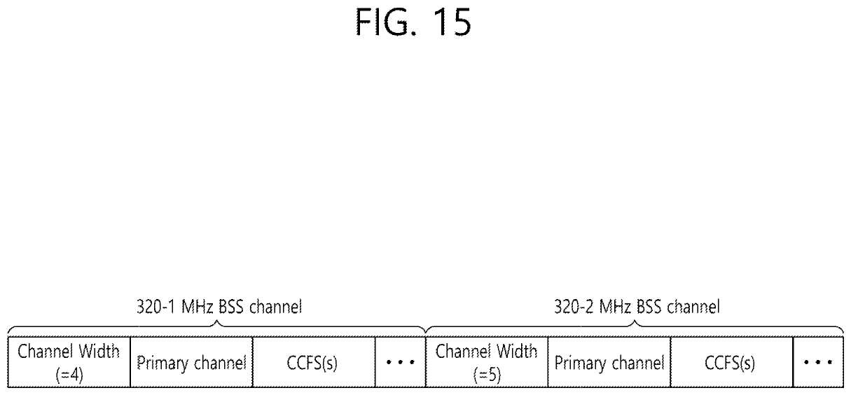

FIG. 15 shows an example of a field for an EHT BSS channel that can indicate two BSS channels.

That is, it is indicated separately without considering the overlapping channel. Therefore, as shown in FIG. 15, there is a BSS channel field capable of indicating two channels, and the channel width allows separately indicating 320-1 MHz and 320-2 MHz as follows.

TABLE 2

| Subfield | Definition | Encoding |
|---|---|---|
| Channel | This field defines | Set to 0 for 20 MHz EHT BSS |
| Width | the EHT BSS bandwidth | bandwidthSet to 1 for 40 MHz |
| | | EHT BSS bandwidth |
| | | Set to 2 for 80 MHz EHT BSS |
| | | bandwidth |
| | | Set to 3 for 160 MHz EHT BSS |
| | | bandwidth |
| | | Set to 4 for 320-1 MHz EHT BSS |
| | | bandwidth |
| | | Set to 5 for 320-2 MHz EHT BSS |
| | | bandwidth |
| | | Other values are reserved. |

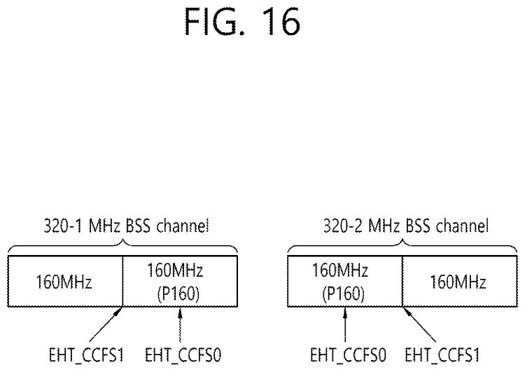

FIG. 16 shows an example of a CCFS subfield in a field for the EHT BSS channel of FIG. 15.

EHT CCFSs (i.e., EHT_CCFS0, EHT_CCFS1) exist for each BSS channel. Referring to FIG. 16, since P160 is located behind CCFS for the 320-1 MHz BSS channel, the second 160 MHz of 320-1 MHz has EHT_CCFS0 and has EHT_CCFS1 for the 320-1 MHz channel. Since the CCFS for the 320-2 MHz BSS channel is located in front of P160, the first 160 MHz of 320-1 MHz has EHT_CCFS0 and the 320-2 MHz channel has EHT_CCFS1.

Meanwhile, the AP may or may not support the capability to change between the 320-1 MHz BSS and the 320-2 MHz BSS. If it is not supported, there may be a Control field (referred to as Capability) for this because there is no need to indicate two channels as above. That is, the value of the Capability field means whether or not both 320-1 MHz and 320-2 MHz can be indicated. For example, assuming that the Capability field is 1 bit, if the value of the Capability field is 1, both 320-1 MHz and 320-2 MHz are indicated, and if the value of the Capability field is 0, both 320-1 MHz and 320-2 MHz cannot be indicated (only one is indicated).

In addition, a Control field (referred to as Current BSS) that can indicate which 320 MHz channel the current BSS uses is also required. For example, assuming that the Current BSS field is 1 bit, and if the value of the Current BSS field is 0, it may indicate that a 320-1 MHz channel is used, and if the value of the Current BSS field is 1, it may indicate that a 320-2 MHz channel is used. In particular, the STA recognizes when the value of the Current BSS field is changed so that the BSS channel can be moved.

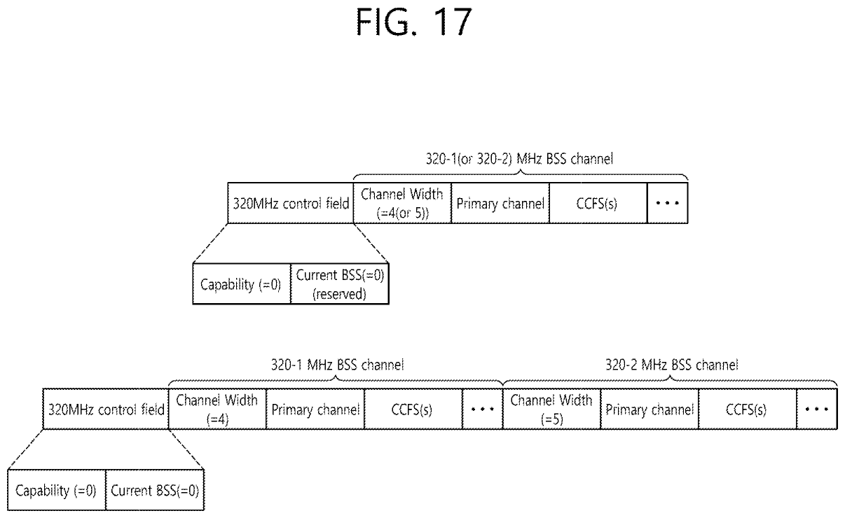

FIG. 17 shows an example of a field for an EHT BSS channel including a 320 MHz Control field.

FIG. 17 may be defined as fields for two types of EHT BSS channels based on the value of the Capability field in the 320 MHz Control field.

Referring to the top of FIG. 17, since the value of the Capability field in the 320 MHz Control field is 0, only one channel for 320 MHz is indicated. Accordingly, since the Current BSS is determined, it is reserved.

Referring to the bottom of FIG. 17, since the value of the Capability field in the 320 MHz Control field is 1, the field for the EHT BSS channel can indicate both 320-1 MHz and 320-2 MHz. Since the value of Current BSS in the 320 MHz Control field is 0, it indicates that the current BSS uses the 320-1 MHz channel.

Meanwhile, the capability field of the 320 MHz control field may exist separately. For example, it can be indicated by separately existing in the EHT Capabilities element. Therefore, according to the indication of the Capability field in the EHT Capabilities element, it can be known whether the field for the EHT BSS channel indicates both 320-1 MHz and 320-2 MHz.

Method 2.1.1 is a simple extension method that repeats existing fields to indicate one more channel, but when the same primary channel includes overlapping channels (For example, if there is an overlapping P160 channel when indicating 320-1 (A) and 320-2 (D)), there may be redundancy overhead caused by simply repeating existing fields. A method for reducing redundancy is proposed in the following method.

2.1.2. If Only 320 MHz is Indicated in Channel Width

That is, considering overlapping channels, 320-1 MHz and 320-2 MHz are indicated together, and they can be distinguished.

The Channel Width field is defined as shown in Table 1.

The primary channel considers the same case in the 320-1 MHz channel and the 320-2 MHz channel.

EHT_CCFS is used to distinguish between 320-1 MHz and 320-2 MHz, and is as follows.
EHT_CCFS0: Channel Center Frequency index of P160
EHT_CCFS1: Channel Center Frequency index for 320-1 MHz channel (320 MHz)
EHT_CCFS2: Channel Center Frequency index for 320-2 MHz channel (320 MHz)

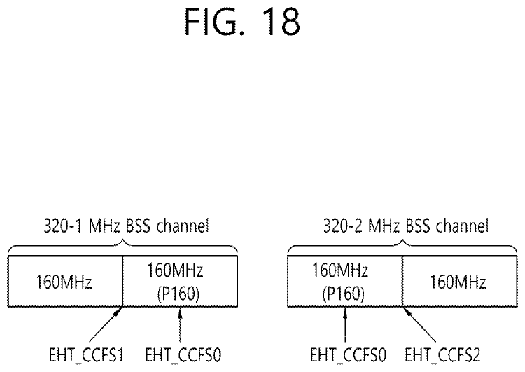

=> That is, P160 is common because it is an overlapping channel, and two channels are distinguished as shown in FIG. 18 using EHT_CCFS1 and EHT_CCFS2.

FIG. 18 shows an example of a CCFS subfield in a field for an EHT BSS channel that can indicate both a 320-1 MHz channel and a 320-2 MHz channel with overlapping channels.

Referring to FIG. 18, since P160 of the 320-1 MHz BSS channel and P160 of the 320-2 MHz BSS channel overlap, they have the same index EHT_CCFS0. It has EHT_CCFS1 for the 320-1 MHz channel and EHT_CCFS2 for the 320-2 MHz channel.

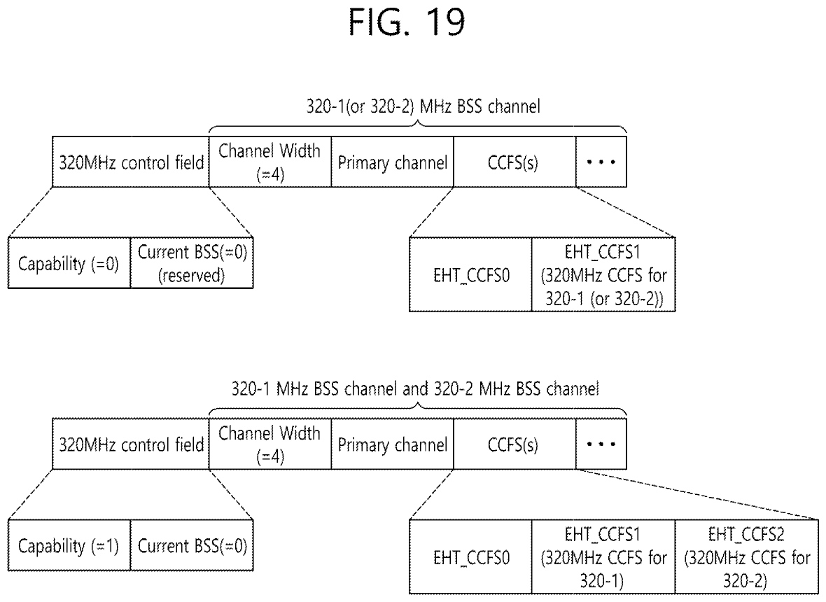

FIG. 19 shows another example of a field for an EHT BSS channel including a 320 MHz Control field.

As in 2.1.1, in the 2.1.2 method, a 320 MHz Control field can be used as shown in FIG. 19. However, when the value of the Capability field in the 320 MHz Control field is 0, EHT_CCFS2 is not used as shown in the upper part of FIG. 19. In EHT_CCFS_1, 320 MHz CCFS of 320-1 MHz channel or 320-2 MHz channel can be indicated. In the upper part of FIG. 19, since the value of the Capability field in the 320 MHz Control field is 0, only one channel for 320 MHz is indicated and EHT_CCFS2 is not included. Accordingly, since the Current BSS is determined, the Current BSS field is reserved.

At the bottom of FIG. 19, since the value of the Capability field in the 320 MHz Control field is 1, the field for the EHT BSS channel can indicate both 320-1 MHz and 320-2 MHz, and includes EHT_CCFS2. Since the value of the Current BSS field in the 320 MHz Control field is 0, it indicates that the current BSS uses the 320-1 MHz channel.

Meanwhile, the capability field of the 320 MHz control field may exist separately. For example, it can be indicated by separately existing in the EHT Capabilities element. Therefore, according to the indication of the Capability field in the EHT Capabilities element, it can be known whether the field for the EHT BSS channel indicates both 320-1 MHz and 320-2 MHz.

Information on the EHT BSS channel described above may be basically indicated in the EHT Operation element of Beacon, Probe Response or Association Response frame.

In addition, basically, information that the BSS has changed can be known through the Current BSS field of the 320 MHz Control field. However, it may not be clear whether the BSS has been changed or maintained as the current BSS only with this information. Since all STAs must indicate the current BSS until they recognize that the BSS has changed, an additional indication that the BSS will be changed may be required. Therefore, in the existing Baseline that the BSS channel will change, information that the 320 MHz BSS channel will be changed may be transmitted through a separate element or field such as an Operating Mode Notification (OMN) element, OMN frame, or OM Control field including an Operating Mode (OM) field that announces changes in channel width and maximum number of spatial streams (SS). This method is as follows.

4.2 Signaling Through EHT Operating Mode (OM) Field

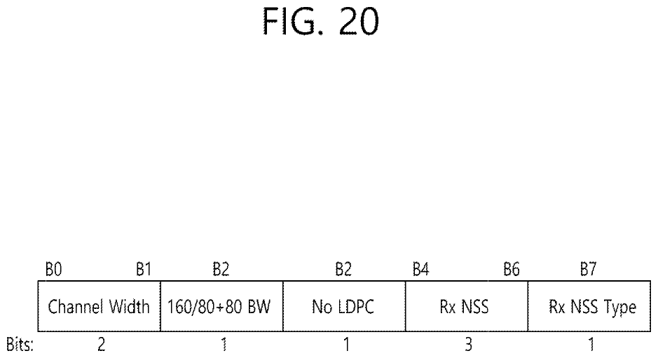

FIG. 20 shows an example of a legacy OM field format.

As shown in FIG. 20, the Legacy Operation Mode field used in the existing 802.11ac/11ax does not have a space for additionally indicating information that the BSS channel will be changed.

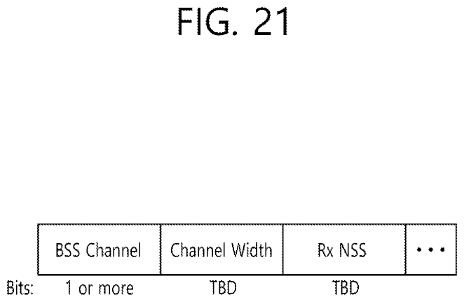

FIG. 21 shows an example of an EHT OM field for notifying a BSS channel change.

Therefore, as shown in FIG. 21, a new EHT OM field capable of supporting channel width for 320 MHz and Rx Number of Spatial Streams (NSS) for 9 to 16 spatial streams (SS) as well as BSS channel change can be defined. In this specification, description is focused on the BSS change subfield rather than the Channel Width and Rx NSS of FIG. 21.

The BSS change subfield has at least 1 bit and can be configured as follows.

A-1) When the BSS change subfield is 1 bit, if the value of the BSS change subfield is 1, it means that the BSS will be changed. That is, it may mean that if the current BSS is 320-1 MHz, it will be changed to 320-2 MHz, or if the current BSS is 320-2 MHz, it will be changed to 320-1 MHz.

A-2) If the BSS change subfield is more than 1 bit (e.g., 2 bit), each index representing the BSS change subfield changes from 320-1 MHz to 320-2 MHz, changes from 320-2 MHz to 320-1 MHz, no channel change (no change), etc.

A-3) The BSS change subfield may have the format of FIG. 14 together with 1 bit of A-1). That is, if the value of 1 bit in A-1) is 1, the BSS change subfield specifically informs the channel for the changed BSS.

=> If the BSS is changed only for 320 MHz, as in the focus of this specification, the channel width may not be included in the format of FIG. 14.

=> If it has the format of FIG. 14, since the OM field contains specific BSS channel information, the EHT Operation element may include only information about the current BSS channel, which is one of the two channels, rather than both the 320-1 MHz and 320-2 MHz BSS channels. If this happens, the current BSS information in the 320 MHz Control field may not exist, and if present, it can be interpreted as follows.

If the value of Current BSS is 1, it indicates no change of BSS, and if the value of Current BSS is 0, it indicates that there is a change of BSS, so the STA can check the EHT OM field to check the BSS channel to be changed.

=> Method A-3) can reduce overhead in EHT Operation IE compared to methods A-1) and A-2).

Similar to the position where the existing OM field is included, the EHT OM field may be included in an EHT OMN (Operating Mode Notification) element, an EHT OMN frame, etc., which may be included in a newly defined management frame.

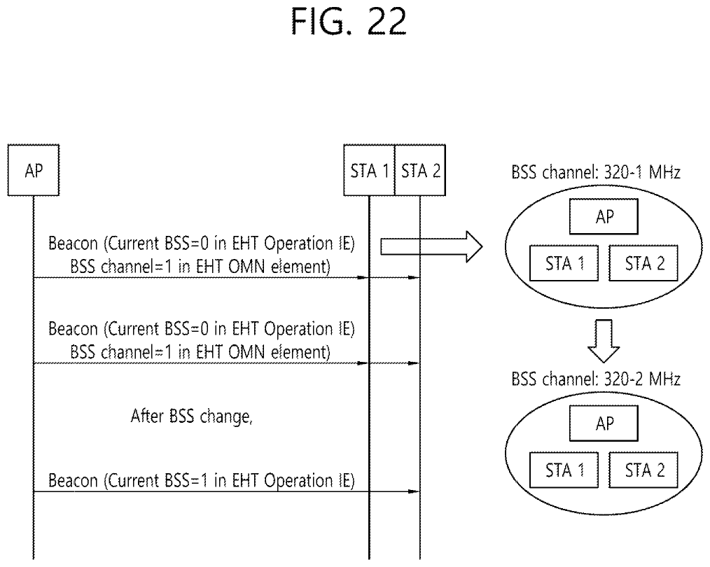

FIG. 22 shows an example of notifying a BSS channel change through method A-1) using an EHT OM field and an EHT Operation IE.

For example, as shown in FIG. 22, if BSS change=1 is included in the Beacon through the EHT OMN element (or EHT OM field) through the A-1) method, the information will be continuously indicated in the Beacon until the BSS is changed. (The value of BSS change included in the received beacon will continue to be 1 until BSS is actually changed). After the BSS channel is changed, the value of Current BSS is changed to 1 in EHT Operation IE (the current BSS channel is a 320-2 MHz channel).

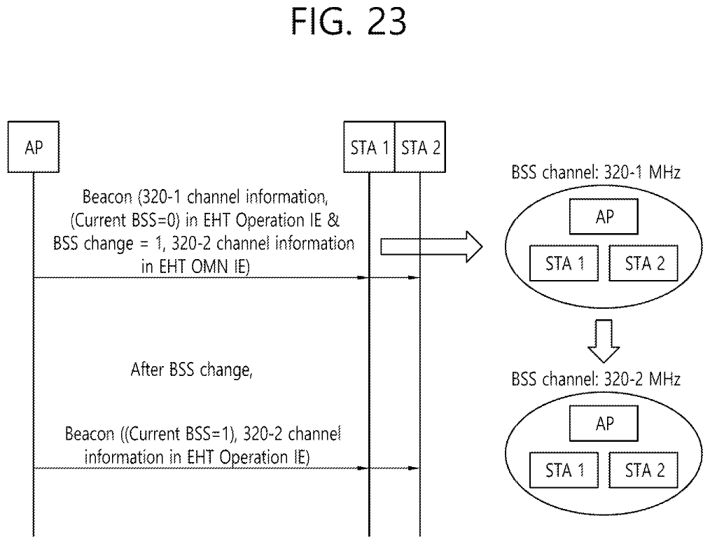

FIG. 23 shows an example of notifying a BSS channel change through method A-3) using an EHT OM field and an EHT Operation IE.

As another example, as shown in FIG. 23, the Beacon's EHT Operation IE includes 320-1 MHz channel information through the A-3) method, BSS change=1 is included in the EHT OMN IE (or EHT OM field) to notify that the BSS will be changed, and information on the 320-2 MHz channel is also included. If the Current BSS field is included in the EHT Operation IE, the value of the Current BSS field may be indicated as 0 to indicate that decoding of the EHT OMN IE (or EHT OM field) is necessary. After the BSS channel is changed, the EHT Operation IE includes 320-2 MHz channel information, and if the Current BSS field is included in the EHT Operation IE, the value of Current BSS is indicated as 1 (the current BSS channel is the 320-2 MHz channel).

Hereinafter, the above-described embodiment will be described with reference to FIGS. 1 to 23.

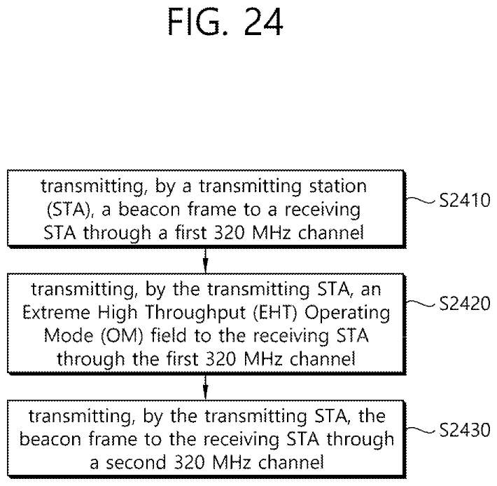

FIG. 24 is a flowchart illustrating a procedure in which an AP indicates a change of a 320 MHz channel according to the present embodiment.

The example of FIG. 24 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

This embodiment proposes a method and apparatus for performing BSS channel change between a 320-1 MHz channel and a 320-2 MHz channel channelized in a 6 GHz band. Here, it is assumed that overlapping primary 160 MHz channels exist in the 320-1 MHz channel and the 320-2 MHz channel. A transmitting STA may correspond to an Access Point Station (AP STA), and a receiving STA may correspond to a non-AP STA.

In step S2410, a transmitting station (STA) transmits a beacon frame to a receiving STA through a first 320 MHz channel.

In step S2420, the transmitting STA transmits an Extreme High Throughput (EHT) Operating Mode (OM) field to the receiving STA through the first 320 MHz channel.

In step S2430, the transmitting STA transmits the beacon frame to the receiving STA through a second 320 MHz channel.

A Basic Service Set (BSS) channel of the transmitting and receiving STAs is changed from the first 320 MHz channel to the second 320 MHz channel based on the beacon frame and the EHT OM field.

This embodiment proposes a method for switching between the first and second 320 MHz channels to increase channel utilization. At this time, since it is assumed that the primary 160 MHz channels of the first and second 320 MHz channels overlap each other, by proposing a switching method of changing only the secondary channels of the first and second 320 MHz channels without changing the primary 160 MHz channel, there is an effect that overhead can be reduced compared to the existing channel switching method.

Specifically, the first and second 320 MHz channel switching methods having overlapping 160 MHz channels can be described as follows.

The beacon frame may include information on the first and second 320 MHz channels. The EHT OM field may include information that the BSS channel of the transmitting and receiving STAs is changed.

When the information that the BSS channel of the transmitting and receiving STAs is changed is set to 1, the BSS channel of the transmitting and receiving STA may be changed from the first 320 MHz channel to the second 320 MHz channel at a preset time point.

The beacon frame may include an EHT Operation element, and the EHT Operation element may include a field for a 320 MHz BSS channel.

Specifically, the information on the first and second 320 MHz channels may include a capability field, a current BSS field, and information on the BSS channel.

The capability field may include information on whether the transmitting STA supports a change between the first and second 320 MHz channels. When the capability field is set to 1, the transmitting STA supports switching between the first and second 320 MHz channels. If the capability field is set to 0, the transmitting STA does not support switching between the first and second 320 MHz channels.

The current BSS field may include information on a current BSS channel of the transmitting and receiving STAs. Until the preset time point, the current BSS field is set to 0, and the current BSS channel of the transmitting and receiving STAs may be the first 320 MHz channel. After the preset time point, the current BSS field is set to 1, and the current BSS channel of the transmitting and receiving STAs may be the second 320 MHz channel. In fact, until the first 320 MHz channel is changed to the second 320 MHz channel, the receiving STA may continuously receive the beacon frame on the first 320 MHz channel, and at this time, the current BSS field included in the beacon frame may be set to 0.

The information on the BSS channel may include a channel bandwidth, a primary channel, and a channel center frequency index for the current BSS channel. The channel center frequency index may include first to third indices. Since the primary 160 MHz channels of the first and second 320 MHz channels overlap each other, the first index may indicate a center frequency of the primary 160 MHz channel. That is, the primary 160 MHz channels of the first and second 320 MHz channels may be indicated by one index. The second index may indicate a center frequency of the first 320 MHz channel, and the third index may indicate a center frequency of the second 320 MHz channel.

The EHT OM field may be included in an EHT Operating Mode Notification (OMN) element or an EHT OMN frame.

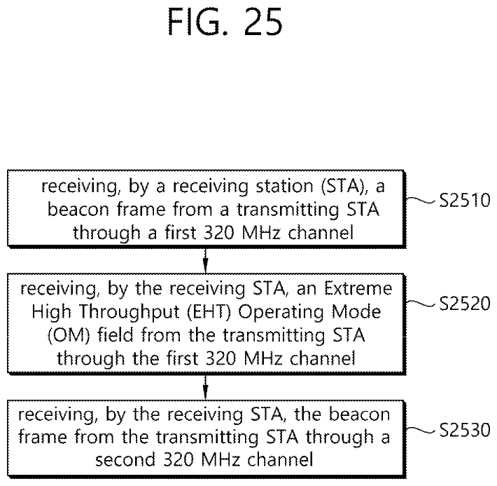

FIG. 25 is a flowchart illustrating a procedure in which an STA is indicated to change a 320 MHz channel according to this embodiment.

The example of FIG. 25 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

This embodiment proposes a method and apparatus for performing BSS channel change between a 320-1 MHz channel and a 320-2 MHz channel channelized in a 6 GHz band. Here, it is assumed that overlapping primary 160 MHz channels exist in the 320-1 MHz channel and the 320-2 MHz channel. A transmitting STA may correspond to an Access Point Station (AP STA), and a receiving STA may correspond to a non-AP STA.

In step S2510, a receiving STA (station) receives a beacon frame from a transmitting STA through a first 320 MHz channel.

In step S2520, the receiving STA receives an Extreme High Throughput (EHT) Operating Mode (OM) field from the transmitting STA through the first 320 MHz channel.

In step S2530, the receiving STA receives the beacon frame from the transmitting STA through a second 320 MHz channel.

A Basic Service Set (BSS) channel of the transmitting and receiving STAs is changed from the first 320 MHz channel to the second 320 MHz channel based on the beacon frame and the EHT OM field.

This embodiment proposes a method for switching between the first and second 320 MHz channels to increase channel utilization. At this time, since it is assumed that the primary 160 MHz channels of the first and second 320 MHz channels overlap each other, by proposing a switching method of changing only the secondary channels of the first and second 320 MHz channels without changing the primary 160 MHz channel, there is an effect that overhead can be reduced compared to the existing channel switching method.

Specifically, the first and second 320 MHz channel switching methods having overlapping 160 MHz channels can be described as follows.

The beacon frame may include information on the first and second 320 MHz channels. The EHT OM field may include information that the BSS channel of the transmitting and receiving STAs is changed.

When the information that the BSS channel of the transmitting and receiving STAs is changed is set to 1, the BSS channel of the transmitting and receiving STA may be changed from the first 320 MHz channel to the second 320 MHz channel at a preset time point.

The beacon frame may include an EHT Operation element, and the EHT Operation element may include a field for a 320 MHz BSS channel.

Specifically, the information on the first and second 320 MHz channels may include a capability field, a current BSS field, and information on the BSS channel.

The capability field may include information on whether the transmitting STA supports a change between the first and second 320 MHz channels. When the capability field is set to 1, the transmitting STA supports switching between the first and second 320 MHz channels. If the capability field is set to 0, the transmitting STA does not support switching between the first and second 320 MHz channels.

The current BSS field may include information on a current BSS channel of the transmitting and receiving STAs. Until the preset time point, the current BSS field is set to 0, and the current BSS channel of the transmitting and receiving STAs may be the first 320 MHz channel. After the preset time point, the current BSS field is set to 1, and the current BSS channel of the transmitting and receiving STAs may be the second 320 MHz channel. In fact, until the first 320 MHz channel is changed to the second 320 MHz channel, the receiving STA may continuously receive the beacon frame on the first 320 MHz channel, and at this time, the current BSS field included in the beacon frame may be set to 0.

The information on the BSS channel may include a channel bandwidth, a primary channel, and a channel center frequency index for the current BSS channel. The channel center frequency index may include first to third indices. Since the primary 160 MHz channels of the first and second 320 MHz channels overlap each other, the first index may indicate a center frequency of the primary 160 MHz channel. That is, the primary 160 MHz channels of the first and second 320 MHz channels may be indicated by one index. The second index may indicate a center frequency of the first 320 MHz channel, and the third index may indicate a center frequency of the second 320 MHz channel.

The EHT OM field may be included in an EHT Operating Mode Notification (OMN) element or an EHT OMN frame.

The technical features of the present disclosure may be applied to various devices and methods. For example, the technical features of the present disclosure may be performed/supported through the device(s) of FIG. 1 and/or FIG. 11. For example, the technical features of the present disclosure may be applied to only part of FIG. 1 and/or FIG. 11. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 11. For example, the device according to the present disclosure receives a beacon frame from a transmitting STA through a first 320 MHz channel; receives an Extreme High Throughput (EHT) Operating Mode (OM) field from the transmitting STA through the first 320 MHz channel; and receives the beacon frame from the transmitting STA through a second 320 MHz channel.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including receiving a beacon frame from a transmitting STA through a first 320 MHz channel; receiving an Extreme High Throughput (EHT) Operating Mode (OM) field from the transmitting STA through the first 320 MHz channel; and receiving the beacon frame from the transmitting STA through a second 320 MHz channel. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 11. Meanwhile, the CRM of the present disclosure may be the memory 112, 122 of FIG. 1, the memory 620 of FIG. 11, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system, the method comprising:
receiving, by a receiving station (STA), a beacon frame from a transmitting STA through a first 320 MHz channel;
receiving, by the receiving STA, an Extreme High Throughput (EHT) Operating Mode (OM) field from the transmitting STA through the first 320 MHz channel; and
receiving, by the receiving STA, the beacon frame from the transmitting STA through a second 320 MHz channel;
wherein a Basic Service Set (BSS) channel of the transmitting and receiving STAs is changed from the first 320 MHz channel to the second 320 MHz channel based on the beacon frame and the EHT OM field.

2. The method of claim 1, wherein the beacon frame includes information on the first and second 320 MHz channels,
wherein the EHT OM field includes information that the BSS channel of the transmitting and receiving STAs is changed,
wherein when the information that the BSS channel of the transmitting and receiving STAs is changed is set to 1, the BSS channel of the transmitting and receiving STA is changed from the first 320 MHz channel to the second 320 MHz channel at a preset time point.

3. The method of claim 2, wherein the information on the first and second 320 MHz channels includes a capability field, a current BSS field, and information on a BSS channel,
wherein the capability field includes information on whether the transmitting STA supports a change between the first and second 320 MHz channels,
wherein the current BSS field includes information on a current BSS channel of the transmitting and receiving STAs,
wherein the information on the BSS channel includes a channel bandwidth, a primary channel, and a channel center frequency index for the current BSS channel.

4. The method of claim 3, wherein primary 160 MHz channels of the first and second 320 MHz channels overlap each other,
wherein the channel center frequency index includes first to third indices,
wherein the first index indicates a center frequency of the primary 160 MHz channel;
wherein the second index indicates a center frequency of the first 320 MHz channel,
wherein the third index indicates a center frequency of the second 320 MHz channel.

5. The method of claim 3, wherein until the preset time point, the current BSS field is set to 0, and the current BSS channel of the transmitting and receiving STAs is the first 320 MHz channel.

6. The method of claim 3, wherein after the preset time point, the current BSS field is set to 1, and the current BSS channel of the transmitting and receiving STAs is the second 320 MHz channel.

7. A receiving station (STA) in a wireless local area network (WLAN) system, the receiving STA comprising:
a memory;
a transceiver; and
a processor operatively coupled to the memory and the transceiver,
wherein processor is configured to:
receive a beacon frame from a transmitting STA through a first 320 MHz channel;
receive an Extreme High Throughput (EHT) Operating Mode (OM) field from the transmitting STA through the first 320 MHz channel; and
receive the beacon frame from the transmitting STA through a second 320 MHz channel;
wherein a Basic Service Set (BSS) channel of the transmitting and receiving STAs is changed from the first 320 MHz channel to the second 320 MHz channel based on the beacon frame and the EHT OM field.

8. A method in a wireless local area network (WLAN) system, the method comprising:
transmitting, by a transmitting station (STA), a beacon frame to a receiving STA through a first 320 MHz channel;
transmitting, by the transmitting STA, an Extreme High Throughput (EHT) Operating Mode (OM) field to the receiving STA through the first 320 MHz channel; and
transmitting, by the transmitting STA, the beacon frame to the receiving STA through a second 320 MHz channel,
wherein a Basic Service Set (BSS) channel of the transmitting and receiving STAs is changed from the first 320 MHz channel to the second 320 MHz channel based on the beacon frame and the EHT OM field.

9. The method of claim 8, wherein the beacon frame includes information on the first and second 320 MHz channels,
wherein the EHT OM field includes information that the BSS channel of the transmitting and receiving STAs is changed,
wherein when the information that the BSS channel of the transmitting and receiving STAs is changed is set to 1, the BSS channel of the transmitting and receiving STA is changed from the first 320 MHz channel to the second 320 MHz channel at a preset time point.

10. The method of claim 9, wherein the information on the first and second 320 MHz channels includes a capability field, a current BSS field, and information on a BSS channel,
wherein the capability field includes information on whether the transmitting STA supports a change between the first and second 320 MHz channels,
wherein the current BSS field includes information on a current BSS channel of the transmitting and receiving STAs,
wherein the information on the BSS channel includes a channel bandwidth, a primary channel, and a channel center frequency index for the current BSS channel.

11. The method of claim 10, wherein primary 160 MHz channels of the first and second 320 MHz channels overlap each other,
wherein the channel center frequency index includes first to third indices,
wherein the first index indicates a center frequency of the primary 160 MHz channel;
wherein the second index indicates a center frequency of the first 320 MHz channel,
wherein the third index indicates a center frequency of the second 320 MHz channel.

12. The method of claim 9, wherein until the preset time point, the current BSS field is set to 0, and the current BSS channel of the transmitting and receiving STAs is the first 320 MHz channel.

13. The method of claim 9, wherein after the preset time point, the current BSS field is set to 1, and the current BSS channel of the transmitting and receiving STAs is the second 320 MHz channel.

14-16. (canceled)
